(19) United States
(12) Patent Application Publication
(10) Pub. No.: US 2025/0097973 A1
(43) Pub. Date: Mar. 20, 2025

(54) STORE-AND-FORWARD OPERATIONS IN NON-TERRESTRIAL NETWORKS

(71) Applicant: Nokia Technologies Oy, Espoo (FI)

(72) Inventors: Jeroen WIGARD, Klarup (DK); Mads LAURIDSEN, Gistrup (DK); Hannu Petri HIETALAHTI, Kiviniemi (FI); Srinivasan SELVAGANAPATHY, Bangalore (IN)

(21) Appl. No.: 18/883,367

(22) Filed: Sep. 12, 2024

(30) Foreign Application Priority Data
Sep. 18, 2023 (IN) 202311062620

(51) Int. Cl. H04W 72/566; H04B 7/185; H04W 8/22; H04W 72/51

(52) U.S. Cl. CPC H04W 72/566; H04B 7/18539; H04W 8/22; H04W 72/51

(57) ABSTRACT

Example embodiments of the present disclosure relate to store-and-forward operations in non-terrestrial networks (NTN). In an aspect, a terminal device receives, from a network device of a NTN, data priority information associated with at least one store-and-forward operation performed by the network device in the NTN. The terminal device performs, based on the data priority information, an operation for uplink data of the terminal device. In this way, the limitations on the storage of the satellite and the feeder link capacity are solved. The data transmission is ensured, and the storage of the satellite is maximally utilized.

### FIELD

Example embodiments of the present disclosure generally relate to the field of communications, and in particular, to devices, methods, apparatuses and a computer readable storage medium for store-and-forward operations in non-terrestrial networks (NTN).

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems, efforts have been made to develop an improved 5th generation (5G), pre-5G, 6G communication systems or beyond.

The store-and-forward (S&F) operation has been defined for Internet of Things (IoT) NTN, and it will allow a satellite to provide service to IoT NTN devices even in periods/areas when/where the satellite is not connected to a Gateway (GW) on the ground.

### SUMMARY

In general, example embodiments of the present disclosure provide a solution for store-and-forward operations in non-terrestrial networks (NTN), especially for handling storage limits in NTN store-and-forward through priority information.

In a first aspect, there is provided a terminal device. The terminal device comprises at least one processor and at least one memory storing instructions that, when executed by the at least one processor, cause the terminal device at least to: receive, from a network device of a non-terrestrial network (NTN), data priority information associated with at least one store-and-forward operation performed by the network device in the NTN; and perform, based on the data priority information, an operation for uplink data of the terminal device.

In a second aspect, there is provided a network device. The network device comprises at least one processor and at least one memory storing instructions that, when executed by the at least one processor, cause the network device at least to: determine data priority information associated with at least one store-and-forward operation performed by the network device in a non-terrestrial network (NTN); and transmit the data priority information to a terminal device.

In a third aspect, there is provided a method. The method comprises receiving, at a terminal device and from a network device of a non-terrestrial network (NTN), data priority information associated with at least one store-and-forward operation performed by the network device in the NTN; and performing, based on the data priority information, an operation for uplink data of the terminal device.

In a fourth aspect, there is provided a method. The method comprises determining, at a network device, data priority information associated with at least one store-and-forward operation performed by the network device in a non-terrestrial network (NTN); and transmitting the data priority information to a terminal device.

In a fifth aspect, there is provided an apparatus. The apparatus comprises means for receiving, at a terminal device and from a network device of a non-terrestrial network (NTN), data priority information associated with at least one store-and-forward operation performed by the network device in the NTN; and means for performing, based on the data priority information, an operation for uplink data of the terminal device.

In a sixth aspect, there is provided an apparatus. The apparatus comprises means for determining, at a network device, data priority information associated with at least one store-and-forward operation performed by the network device in a non-terrestrial network (NTN); and means for transmitting the data priority information to a terminal device.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a terminal device. The terminal device comprises receiving circuitry configured to receive, from a network device of a non-terrestrial network (NTN), data priority information associated with at least one store-and-forward operation performed by the network device in the NTN; and performing circuitry configured to perform, based on the data priority information, an operation for uplink data of the terminal device.

In a tenth aspect, there is provided a network device. The network device comprises determining circuitry configured to determine data priority information associated with at least one store-and-forward operation performed by the network device in a non-terrestrial network (NTN); and transmitting circuitry configured to transmit the data priority information to a terminal device

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which example embodiments of the present disclosure can be implemented;

FIG. 2 illustrates a process flow of method according to some embodiments of the present disclosure;

FIG. 3 illustrates a detailed example of interactions between a user equipment and a satellite in accordance with some example embodiments of the present disclosure;

FIG. 4 illustrates a detailed example of a process flow in accordance with some example embodiments of the present disclosure;

FIG. 5 illustrates a flowchart of a method performed by an apparatus in accordance with some example embodiments of the present disclosure;

FIG. 6 illustrates a flowchart of a method performed by an apparatus in accordance with some example embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuits (such as in analog and/or digital circuits) and
(b) combinations of hardware circuits and software, such as (as applicable):
   (i) a combination of analog and/or digital hardware circuit(s) with software (e.g., firmware); and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “cellular network” refers to a network operating in accordance with any suitable radio access technology defined by standards, such as Long Term Evolution (LTE), LTE-Advanced (LTE-A), new radio Wideband Code Division Multiple Access (WCDMA), High-Speed Packet Access (HSPA), Narrow Band Internet of Things (NB-IoT) and so on. Furthermore, the communications between a terminal device and a network device of a cellular network may be performed according to any suitable communication protocols, including, but not limited to, the fourth generation (4G), 4.5G, the future fifth generation (5G) communication protocols, and/or any other protocols either currently known or to be developed in the future. Embodiments of the present disclosure may be applied in various cellular networks. Given the rapid development in communications, there will of course also be future type communication technologies and systems with which the present disclosure may be embodied. It should not be seen as limiting the scope of the present disclosure to only the aforementioned system.

As used herein, the term “network device” refers to any device in a cellular network via which a terminal device accesses a data network and receives services exposed by other network devices of the cellular network. In some examples, a network device may comprise or implement a network function of a 5^{th} generation communication system (5GS) (e.g., a core network) of a cellular network. In some examples, the network devices may be located at the RAN of the 5GS. The network device may be part of a satellite, a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico node, and so forth, depending on the applied terminology and technology. A gNB may include a centralized unit CU and one or more distributed DUs. Femto and Pico nodes are small base stations with a small coverage area.

The term “terminal device” refers to a device of a communication system of a cellular network, such as a 5^{th} generation communication system (5GS) that may be capable of wireless (e.g., radio) communication with a NR-RAN of the 5GS). By way of example rather than limitation, a terminal device may also be referred to as a wireless communication device, user equipment (UE), a Subscriber Station (SS), a Portable Subscriber Station, a Mobile Station (MS), or an Access Terminal (AT). Examples of a terminal device include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The store-and-forward operation may enable a satellite to deliver services to IoT NTN devices, even when the satellite lacks a connection to a ground-based Gateway, either due to time or location constraints. The store and forward operation is built on the discontinuous coverage scenario, where the UE only occasionally and temporarily has coverage from a satellite and/or the satellite is not always connected with the core network. The store and forward architecture enables a low-cost deployment consisting of just a few satellites and a few ground stations, and it means the connectivity cost per device can be further reduced at the cost of only being able to support delay-tolerant data.

In some use cases, the IoT remote monitoring UE needs to send a message to an application server. The UE waits for satellite network coverage and sends its message when the satellite passes by. The IoT remote monitoring UE and the satellite providing coverage interact over the service link, allowing the UE to transfer the message to the satellite, which has no connectivity to the ground segment. Consequently, the satellite has to store locally the received message. At this point, the limitations to the size/amount of data that can be sent from the UE could be enforced. The forwarding priority for the stored data to the ground station and data retention period for the exchanged data could be established. Acknowledgement of the received data by the satellite could be issued.

At a later time, the satellite with the stored message establishes connectivity with the ground network via a feeder link and relays/forwards/downloads the message to the ground network. The satellite may fly between two GWs without connectivity and the two GW may be the same GW, while it is collecting data from devices on Earth. At the same time, the satellite may deliver data to the devices on the ground. However, the storage of the satellite is limited. Another limitation may be the feeder link capacity during the time the satellite is connected to the GW. This limitation may be addressed in similar manner as the storage limitation. A problem, among others, needs to be solved is how to ensure that no data is lost while the storage of the satellite is maximally utilized.

In view of the above, example embodiments of the present disclosure provide a solution store-and-forward operations in non-terrestrial networks (NTN), particularly for handling storage limits in NTN store-and-forward through priority information. In the example embodiments of the present disclosure, a terminal device may receive, from a network device of a non-terrestrial network (NTN), data priority information associated with at least one store-and-forward operation performed by the network device in the NTN. The terminal device may further perform, based on the data priority information, an operation for uplink data of the terminal device. In this way, the limitations on the storage of the satellite and the feeder link capacity are solved. The data transmission is ensured, and the storage of the satellite is maximally utilized.

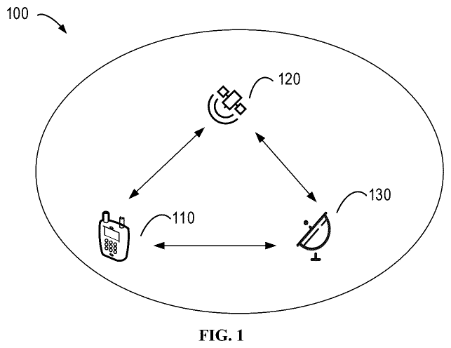

FIG. 1 illustrates an example of a network environment 100 in which example embodiments of the present disclosure can be implemented. The environment 100 may be a part of a communication network and comprise a plurality of terminal devices and network devices, such as a terminal device 110, a network device 120, and a network device 130. As an example, the terminal device 110 may be implemented as a User Equipment (UE) or an Access Terminal (AT), and the network device 120 may be implemented as a satellite (eNB), or a base station (BS). The network device 130 may be implemented as a gateway (GW), and, for example, it may connect the terminal device 110 and the network device 120 with parts of the core network. The terminal device 110 may communicate and transmit various data to the network device 120 and network device 130 via network environment 100. The network device 130 may also transmit various data to the terminal device 110 and network device 120 via network environment 100.

To transmit data and/or control information, the terminal device 110 may perform communications with the network device 120. A link from the network device 120 to the terminal device 110 is referred to as a downlink (DL), while a link from the terminal device 110 to the network device 120 is referred to as an uplink (UL).

Although the terminal device 110 and the network device 120 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the terminal device is schematically depicted as a mobile phone and the network device 120 is schematically depicted as a satellite in FIG. 1, it is understood that these depictions are exemplary in nature without suggesting any limitation. In other embodiments, the first device 110 and the network device 120 may be any other communication devices, for example, any other wireless communication devices.

It is to be understood that the particular number of various communication devices and the particular number of various communication links as shown in FIG. 1 is for illustration purpose only without suggesting any limitations. The communication environment 100 may include any suitable number of communication devices and any suitable number of communication links for implementing embodiments of the present disclosure. In addition, it should be appreciated that there may be various wireless as well as wireline communications (if needed) among all of the communication devices.

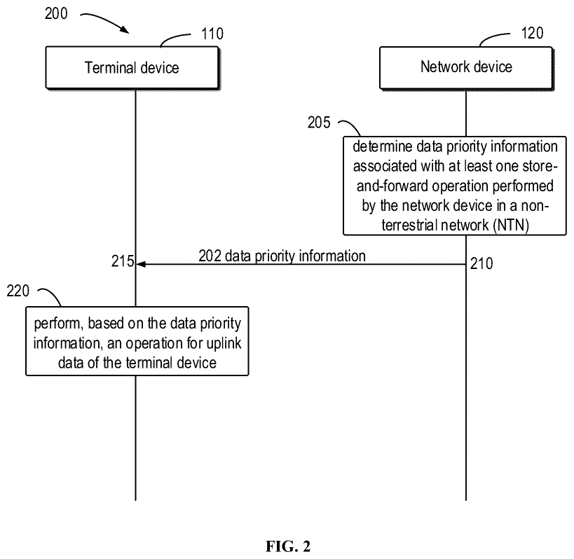

FIG. 2 illustrates a process flow of method according to some embodiments of the present disclosure. For the purpose of discussion, the process flow 200 will be described with reference to FIG. 1. It would be appreciated that although the process flow 200 has been described referring to FIG. 1, this process flow 200 may be likewise applied to other similar communication scenarios.

In the process flow 200, the network device 120 may determine (205) data priority information 202 associated with at least one store-and-forward operation performed by the network device in a non-terrestrial network (NTN). The data priority information 202 may indicate a factor affecting the priority of data, such as a remaining storage of the network device, remaining time until the network device connects to a gateway, and/or a ratio of the remaining storage to the remaining time. The NTN may comprise more than one network devices.

The data priority information 202 may also indicate a factor affecting the priority of data, such as a number of times for which the data has been (re)transmitted, a data type of the data, a subscription type of the terminal device 110, a quality of service (QoS) of the data, a latency requirement of the data, a criticality status of the data, and/or a radio resource control (RRC) establishment cause used by the terminal device 110. The data priority information 202 may comprise a first priority of first data of the terminal device 110 and/or a second priority of second data of the terminal device.

In some embodiments, the data priority information 202 may indicate a lower data priority when the data priority information is associated with a first remaining storage than when the data priority information 202 is associated with a second remaining storage, if the second remaining storage is larger than the first remaining storage.

In some other embodiments, the data priority information 202 may indicate a lower data priority when the data priority information 202 is associated with a first remaining time than when the data priority information 202 is associated with a second remaining time, if the second remaining time is less than the first remaining storage. In the context of this disclosure, the remaining time may refer to a duration left until the satellite expects to connect with a gateway.

In some further embodiments, the data priority information 202 may indicate a lower data priority when the data priority information 202 is associated with a first ratio than when the data priority information is associated with a second ratio, if the second ratio is greater than the first ratio. In the context of this disclosure, the ratio may refer to a ratio between the remaining storage and the remaining time.

Alternatively, or additionally, in some further embodiments, the data priority information 202 may indicate a lower data priority when the data priority information 202 is associated with the uplink data than when the data priority information 202 is associated with a feedback to downlink data. In some further embodiments, the data priority information 202 may indicate a lower data priority when the data priority information is associated with a first subscription class than when the data priority information is associated with a second subscription class, if the second subscription class is higher than the first subscription class. In some embodiments, the QoS, the latency requirement, and/or the criticality status of the uplink data may be determined based on logical channel prioritization.

The network device 120 may then transmit (210) the data priority information 202 to the terminal device 110. The terminal device 110 may then receive (215) the data priority information 202 associated with at least one store-and-forward operation performed by the network device in the NTN from the network device 120. In some embodiments, the terminal device 110 may receive the data priority information 202 by receiving system information indicating the data priority information 202 from the network device 110.

Alternatively, or additionally, in some embodiments, the terminal device 110 may receive the data priority information 202 by receiving an RRC message indicating the data priority information 202 from the network device 120. In some embodiments, the terminal device 110 may transmit a scheduling request or a buffer status report to the network device 120, and the data priority information 202 is received in a scheduling grant responsive to the scheduling request or the buffer status report.

In some further embodiments, the terminal device 110 may transmit the data to the network device 120, and the data priority information 202 is received by the terminal device 110 from the network device 120 based on transmitting the data. Alternatively, or additionally, the data may be transmitted in a message 3 during a random access procedure, and the data priority information 202 may be received in a message 4 during the random access procedure.

The terminal device 110 may then perform (220) an operation for uplink data of the terminal device 110 based on the data priority information 202. The operation may comprise transmitting the data to the network device, postponing transmitting the data to the NTN, or dropping the data. For example, the terminal device 110 may postpone transmitting the data to the current network device 120 or another network device (satellite) providing service to the area of the terminal device 110 at a later point in time.

In some further embodiments, the operation may further comprise deleting the data based on determining that a priority of the data is higher than a first threshold; retransmitting the data or reinitiating a signalling procedure for transmitting the data, after a first time period since an expected time of receiving an acknowledgement of the data based on determining that the priority of the data is lower than the first threshold and higher than a second threshold; based on determining that the priority of the data is lower than the second threshold, retransmitting the data or reinitiating the signalling procedure after a second time period determined based on the priority of the data; retransmitting the data to the first network device or a second network device in the NTN during a subsequent connection to the first network device or the second network device based on determining that the priority of the data is lower than a third threshold.

In some example scenarios, the terminal device 110 may transmit first information indicating that the data is retransmitted data or postponed data to the first network device or the second network device based on retransmitting the data or reinitiating the signalling procedure. In some further embodiments, the terminal device 110 may prevent from transmitting the data to the network device 120 by determining that the terminal device 110 is barred from accessing a cell of the network device 120 based on the data priority information 202.

In some example implementations, the terminal device 110 may receive second information indicating that storage of the network device 120 is exhausted from the network device 120. The second information may be received via broadcasted information, a scheduling grant and/or a RRC release cause. In some embodiments, the terminal device 110 may receive third information from the network device 120, and the third information may indicate that data with a QoS, a latency requirement, or a criticality status above a threshold level is allowed to be transmitted to the network device 120.

In some cases, for example, the network device 120 may be referred to as a first network device, and the terminal device 110 may retransmit the data to the first network device or to a second network device in the NTN during a subsequent connection to the first network device or to the second network device based on receiving fourth information from the first network device or from the second network device. The fourth information may indicate that data transmitted to the first network device is dropped by the first network device. The fourth information may be received via a paging message or indicated in the subsequent random access procedure for the terminal device 110.

In some events, for instance, the terminal device 110 may receive fifth information from the network device 120, and fifth information may indicate whether the data priority information 202 applies to one or a subset of a plurality of cells of the network device 120 or applies to the plurality of cells. In some embodiments, the terminal device 110 may obtain configuration information for configuring the terminal device 110 with a store-and-forward (SF) access class among a plurality of SF access classes.

The terminal device 110 may also receive system information indicating at least one barred SF access class among the plurality of SF access classes from the network device 120. The terminal device 110 may then determine whether the terminal device 110 is barred from accessing a cell of the network device 120 based on the SF access class of the terminal device 110 and the at least one barred SF access class. In some embodiments, the terminal device 110 may obtain the configuration information by receiving the configuration information from the network device 120, or determine the configuration information which is predefined for the terminal device 110.

In some example embodiments, the terminal device 110 may receive sixth information from the network device 120, and the sixth information indicates the terminal device 110 to release the data from an application buffer of the terminal device 110 or to maintain the data in the application buffer. In some further embodiments, the terminal device 110 may receive a buffer status report (BSR) in a downlink direction for indicating a share of storage of the network device 120 available for the terminal device 110 from the network device 120. The terminal device 110 may then perform the operation related to the data further based on the BSR.

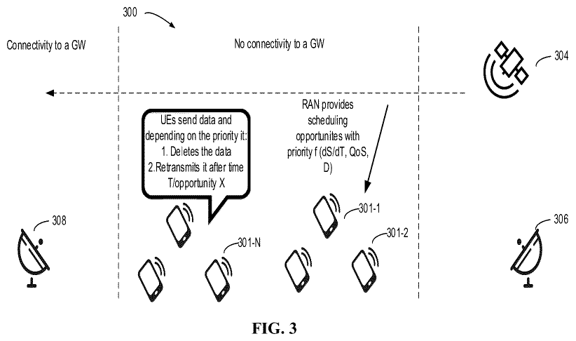

FIG. 3 illustrates a detailed example of interactions 300 between a user equipment (UE) and a satellite (eNB) in accordance with some example embodiments of the present disclosure. It is noted that FIG. 3 can be deemed as a further example of the process flow 200. For example, the UEs 301-1 to 301-N may be example devices of the terminal device 110, and the satellite 304 may be the example devices of the network device 120. It is to be understood that these devices are described only for the purpose of illustration without suggesting any limitation as to the scope of the disclosure. This process will be described in detail as follows.

As illustrated in FIG. 3, a satellite (eNB) 304 may have a certain amount of total Storage S and have a certain flight time between a first gateway (GW) 306 and a second GW 308. The flight time may be denoted with T. In some embodiments, the first GW 306 and second GW 308 may be the same GW. The satellite 304 may have a certain amount of data D to be delivered to the UEs 301-1 to 301-N, and the free storage of the satellite 304 may be S-D.

In some embodiments, the storage of the satellite 304 may not be shared between uplink and downlink buffers and the free storage of the satellite 304 may be S for uplink data. The satellite 304 at any point in time may first offload its data to the UEs 301-1 to 301-N to maximize the available storage if memory is shared between uplink and downlink. In order for the UEs 301-1 to 301-N to upload their data, the gNB at the satellite 304 may assign them with priorities and indicate the assigned priorities to the UEs 301-1 to 301-N.

The priority may be a function of at least one of the following elements: remaining storage in the satellite 304, and a lower storage may lead to a lower priority; remaining time until next GW, such as the GW 308, and more time may lead to a lower priority; remaining storage/remaining time ratio, and lower ratios may lead to lower priorities; and/or same elements as described above but taking all or a part of the data meant for devices 301-1 to 301-N (downlink data) out of the equation because it will be delivered before the next GW.

The priority also may be a function of at least one of the following elements: the amount of times the data has been retransmitted; the data type; subscription type/class; Quality of Service (QoS)/latency requirements/criticality (e.g. emergency) status of the data; and/or radio resource control (RRC) establishment cause used by the UEs 301-1 to 301-N. Regarding the data type, new data may have a lower priority than application layer feedback to data, which was previously provided in the downlink. Thus, in some embodiments, for example, the UE 301-1 may indicate the data is “application layer feedback” to the satellite 304, and then the data may be associated with a high priority.

Regarding the subscription type, a low-cost subscription or low subscription class is always associated with low priority and a high-cost subscription or high subscription class is associated with higher priority. The QoS/latency requirements/criticality status of the data may be based on the logical channel prioritization. The RRC Establishment cause may be mo-Data, mo-signalling, highPriorityAccess, emergency, etc.

It is noted that the priority information may be given in the scheduling grant or after the data has been uploaded. For example, in case of Early Data Transmission (EDT), the UE 301-1 may provide the data in message 3 (msg3) to the satellite 304. In some embodiments, the satellite 304 may respond with the assigned priority in message 4 (msg4) or provide a table in System Information Broadcast, and the table may define a mapping between one or more of the elements in QoS/latency requirements/criticality status of the data and the priority. Alternatively, or additionally, the satellite 304 may provide a general priority based one or more of the elements in the functions described above. It is noted that such information may also be broadcasted even if EDT is not used.

The UE 301-1 may then upload its data depending on the priority. For example, the UE 301-1 may delete the data when the priority was high (above a network configured or specification threshold) and the data delivery is guaranteed. In some embodiments, for example, the UE 301-1 may retransmit the data or re-initiate a signaling procedure after time x when the priority was high but not guaranteed. The time x is after the expected time of receiving an acknowledgement of the data.

In some embodiments, the UE 301-1 may retransmit the data or re-initiate the signaling procedure after time y, and the time y is depending on the priority. For example, in the case of a lower or the lowest priority, the UE 301-1 may retransmit at the next opportunity when the next satellite moves by, because the data was most likely dropped from the previous satellite 304. As another example, in the case of a higher priority, the UE 301-1 may decide not to retransmit the data or re-transmit the data at a later (i.e. not next) opportunity when the next satellite moves by, because the data was probably kept in the previous satellite 304. It is noted that in the context of this disclosure, a “lower priority” may refer to a priority that is lower than a predetermined threshold configured by a network or specification threshold. Likewise, a “high priority” may refer to a priority that is higher than a predetermined threshold configured by a network or specification threshold. A “lowest priority” may refer to a priority that is lowest among a range of a predetermined priority range configured by a network or specification range, and “highest priority” may refer to a priority that is highest among a range of predetermined priority configured by a network or specification range.

In the scenario that the UE 301-1 retransmits the data or re-initiates a signaling procedure after the time x or the time y, the UE 301-1 may inform Radio Access Network (RAN) that this is a retransmission, such that the network may apply a higher priority and detect duplicates. Likewise, the UE 301-1 may inform that this is postponed data (from a previous connection) after which the satellite 304 may assign a higher priority, and possibly indicate the priority of the data to the UE 301-1.

In some further embodiments, the satellite 304 may broadcast/indicate in scheduling grant that it currently has used all its memory. The satellite 304 may also provide this information as a RRC Release cause to UEs 301-1 to 301-N. If very limited storage space is available in the satellite 304, the satellite 304 may indicate only data with a QoS/latency/criticality requirement above a certain level is allowed.

In another embodiment, if the satellite 304 has initially accepted data from a UE 301-1 with a low or high priority, but the satellite 304 is later forced to drop it due to receiving higher priority data from this UE 301-1 or other UEs 301-2 to 301-N, the satellite 304 may inform the UE 301-1, if the UE 301-1 is still in coverage of the satellite 304, that the data was dropped and that UE may need to retransmit the data towards the next satellite.

The notification about the dropped data may be provided from one cell of the satellite 304 even if the data was originally delivered to another cell of the same satellite 304. For example, this may apply in the case of earth moving cells, where multiple cells from the eNB on the satellite 304 will provide coverage in a sequential manner to the UE 301-1. The memory of the satellite 304 may be allocated per cell or per eNB. Therefore, the cell may indicate whether the priority and data handling only applies to the current cell or any cell of the current satellite.

In some embodiments, the UE 301-1 may be barred from accessing the cell based on the data priority until the UE 301-1 is paged. For example, the satellite 304 or specification may define access classes linked to the priority, such that the satellite 304 may bar access to a certain cell based on the UE's data priority.

Alternatively, or additionally, in some embodiments, the satellite 304 may indicate a Mobile Originated User Equipment Random Access Channel (MO UE RACH) access control based on storage capacity status. For example, the satellite 304 may configure a new class for ‘store-and-forward (SF)-Access class’ to each UE as part of registration or first connection setup. The SF-Access class value may be assigned based on static access-class and emergency or priority of data and whether the transmission is first or retransmission.

Similar to access class barring, the satellite 304 may broadcast at least one ‘SF-Access class’ to be barred among the plurality of SF-Access classes via system information. The percentage of classes to be barred may depend on ‘storage capacity’. When storage capacity of satellite 304 is full, it may bar all the SF-Access classes. For some UEs which are not aware of the SF-Access class, existing access-class barring may be used. Access barring for storage may be lifted when some mobile terminated (MT) data is delivered and storage is released/available.

Alternatively, or additionally, in some embodiments, the satellite 304 may purge of some old UE data to accommodate new high priority UE traffic. Depending on the current load and expected remaining time, the satellite 304 may indicate whether the UE 301-1 can release its packet from its application buffer or maintain it for potential release of packets due to pre-emption under storage overload situation. A paging message for specific UE may indicate the ‘release’ of packets. The UE may then indicate to its application about the release of the application payload so that the application can attempt in next satellite without waiting for acknowledgment. The paging message can include the identifier of the UE and amount of packets dropped starting from the first packet received.

In some further embodiments, the satellite 304 may transmit a buffer status report (BSR) in downlink direction to each UE based on the share of storage space for each UE. The UE may control its uplink packets based on this BSR. This can be token which may be converted into actual packet or buffers reserved at GNB in SF network.

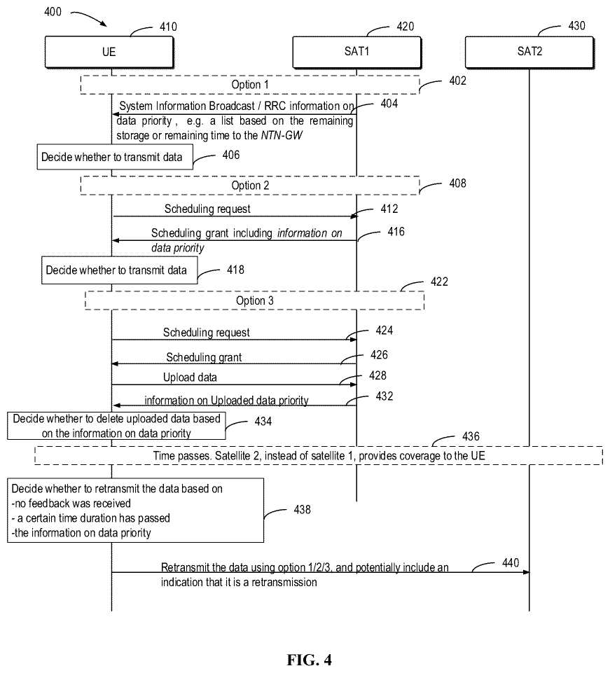

FIG. 4 illustrates a detailed example of a process flow 400 in accordance with some example embodiments of the present disclosure. It is noted that the process flow 400 can be deemed as a further example of the process flow 200. For example, the UE 410 may be one of the example devices of the terminal device 110, the satellites 420 and 430 may be the example devices of the network device 120. It is to be understood that these devices are described only for the purpose of illustration without suggesting any limitation as to the scope of the disclosure. This process will be described in detail as follows.

As illustrated in FIG. 4, the satellite 420 may have several options to indicate the priority information. In the option 1 which is denoted as 402, the satellite 420 may broadcast system information or an RRC message 404 indicating data priority information to the UE 410, and the data priority information may be associated with the remaining storage or remaining time to a next gateway. At 406, upon receiving the data priority information, the UE 410 may decide whether to transmit data to the satellite 420.

In the option 2 which is denoted as 408, the UE 410 may transmit a scheduling request 412 to the satellite 420. Upon receiving the scheduling request 412 from UE 410, the satellite 420 may transmit a scheduling grant 416 including data priority information to the UE 410. At 418, upon receiving the scheduling grant 416, the UE 410 may decide whether to transmit data to the satellite 420.

In the option 3 which is denoted as 422, the UE 410 may transmit a scheduling request 424 to the satellite 420. Upon receiving the scheduling request 424 from the UE 410, the satellite 420 may transmit a scheduling grant 426 to the UE 410. The UE 410 may upload the data 428 to the satellite 420. After receiving the data uploaded from UE 410, the satellite 420 may transmit data priority information 432 related to the uploaded data to the UE 410. At 434, the UE 410 may then decide whether to delete the uploaded data or keep it for later transmission based on the data priority information.

At 436, when the time passes, the satellite 430 may provide coverage to the UE 410 instead of the satellite 420. At 438, the UE 410 may then decide whether to retransmit the data based on no feedback was received from the satellite 420 or from satellite 430 or any other network node, a certain time duration has passed, or the information on data priority received from satellite 420. At 440, if the UE 410 decides to retransmit the data, it may use the methods described in the options 1-3. The UE 410 may also indicate that this is a retransmission to the satellite 430.

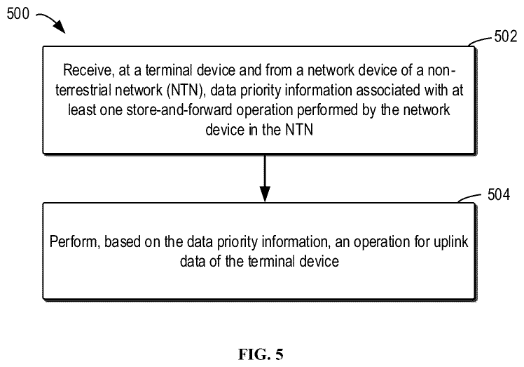

FIG. 5 illustrates a flowchart of a method 500 performed by an apparatus in accordance with some example embodiments of the present disclosure. For the purpose of discussion, the method 500 will be described from the perspective of the terminal device 110 with reference to FIG. 1.

At block 502, the terminal device 110 may receive, from a network device of a non-terrestrial network (NTN), data priority information associated with at least one store-and-forward operation performed by the network device in the NTN. At block 504, the terminal device 110 may perform, based on the data priority information, an operation for uplink data of the terminal device 110.

In some embodiments, the data priority information is based on at least one of the following: a remaining storage of the network device; remaining time until the network device connects to a gateway; or a ratio of the remaining storage to the remaining time. In some further embodiments, the data priority information is based on at least one of the following: a number of times for which the data has been retransmitted; a data type of the data; a subscription type of the terminal device 110; a quality of service (QoS) of the data; a latency requirement of the data; a criticality status of the data; or a radio resource control (RRC) establishment cause used by the terminal device 110.

In some embodiments, the data priority information indicates a lower data priority when the data priority information is associated with a first remaining storage than when the data priority information is associated with a second remaining storage, wherein the second remaining storage is larger than the first remaining storage; the data priority information indicates a lower data priority when the data priority information is associated with a first remaining time than when the data priority information is associated with a second remaining time, wherein the second remaining time is less than the first remaining storage; or the data priority information indicates a lower data priority when the data priority information is associated with a first ratio than when the data priority information is associated with a second ratio, wherein the second ratio is greater than the first ratio.

In some embodiments, the data priority information indicates a lower data priority when the data priority information is associated with the uplink data than when the data priority information is associated with a feedback to downlink data; the data priority information indicates a lower data priority when the data priority information is associated with a first subscription class than when the data priority information is associated with a second subscription class, wherein the second subscription class is higher than the first subscription class; at least one of the QoS, the latency requirement, or the criticality status of the uplink data is determined based on logical channel prioritization.

In some embodiments, the terminal device 110 is caused to receive the data priority information by at least one of the following: receiving, from the network device, system information indicating the data priority information; or receiving, from the network device, an RRC message indicating the data priority information. In some embodiments, the terminal device 110 is further caused to transmit a scheduling request or a buffer status report to the network device, wherein the data priority information is received in a scheduling grant responsive to the scheduling request or the buffer status report.

In some embodiments, the terminal device 110 is further caused to transmit the data to the network device, wherein the data priority information is received by the terminal device 110 from the network device based on transmitting the data. The data is transmitted in a message 3 during a random access procedure. The data priority information is received in a message 4 during the random access procedure. In some embodiments, the operation performed by the terminal device 110 based on the data priority information comprises: transmitting the data to the network device; postponing transmitting the data to the NTN; or dropping the data.

In some embodiments, the data is transmitted to the network device, the network device is a first network device, and the operation further comprises: based on determining that a priority of the data is higher than a first threshold, deleting the data; based on determining that the priority of the data is lower than the first threshold and higher than a second threshold, retransmitting the data or reinitiating a signalling procedure for transmitting the data, after a first time period since an expected time of receiving an acknowledgement of the data; based on determining that the priority of the data is lower than the second threshold, retransmitting the data or reinitiating the signalling procedure after a second time period determined based on the priority of the data; or based on determining that the priority of the data is lower than a third threshold, retransmitting the data to the first network device or a second network device in the NTN during a subsequent connection to the first network device or the second network device.

In some embodiments, the terminal device 110 is further caused to: based on retransmitting the data or reinitiating the signalling procedure, transmit, to the first network device or the second network device, first information indicating that the data is retransmitted data or postponed data. The terminal device 110 is caused to prevent from transmitting the data to the network device by determining, based on the data priority information, that the terminal device 110 is barred from accessing a cell of the network device.

In some embodiments, the terminal device 110 is further caused to receive, from the network device, second information indicating that storage of the network device is exhausted. The second information is received via at least one of the following: broadcasted information; a scheduling grant; or a RRC release cause. In some embodiments, the terminal device 110 is further caused to receive, from the network device, third information indicating that data with at least one of a QoS, a latency requirement, or a criticality status above a threshold level is allowed to be transmitted to the network device.

In some embodiments, the network device is a first network device, and the terminal device 110 is further caused to, based on receiving, from at least one of the first network device or a second network device, fourth information indicating that data transmitted to the first network device is dropped by the first network device, retransmit the data to the first network device or a second network device in the NTN during a subsequent connection to the first network device or the second network device. The fourth information is received via a paging message for the terminal device 110.

In some embodiments, the terminal device 110 is further caused to receive, from the network device, fifth information indicating whether the data priority information applies to one of a plurality of cells of the network device or applies to the plurality of cells. In some embodiments, the terminal device 110 is further caused to obtain configuration information for configuring the terminal device 110 with a store-and-forward (SF) access class among a plurality of SF access classes; receive, from the network device, system information indicating at least one barred SF access class among the plurality of SF access classes; and determine, based on the SF access class of the terminal device 110 and the at least one barred SF access class, whether the terminal device 110 is barred from accessing a cell of the network device. The terminal device 110 is caused to obtain the configuration information by receiving the configuration information from the network device; or determine the configuration information which is predefined for the terminal device 110.

In some embodiments, the terminal device 110 is further caused to receive, from the network device, sixth information indicating the terminal device 110 to release the data from an application buffer of the terminal device 110 or to maintain the data in the application buffer. In some embodiments, the terminal device 110 is further caused to: receive, from the network device, a buffer status report (BSR) in a downlink direction for indicating a share of storage of the network device for the terminal device 110; and perform the operation related to the data further based on the BSR. The data priority information comprises at least one of the following: a first priority of first data of the terminal device 110; or a second priority of second data of the terminal device 110.

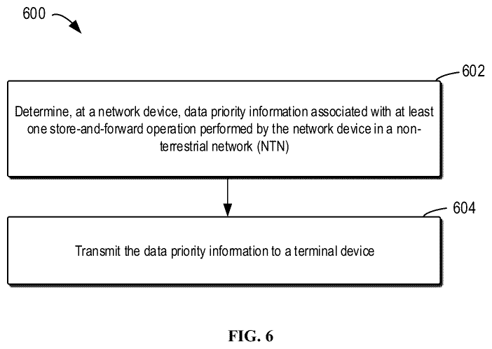

FIG. 6 illustrates a flowchart of a method 600 performed by an apparatus in accordance with some example embodiments of the present disclosure. For the purpose of discussion, the method 600 will be described from the perspective of the network device 120 with reference to FIG. 1.

At block 602, the network device 120 may determine data priority information associated with at least one store-and-forward operation performed by the network device in a non-terrestrial network (NTN). At block 604, the network device 120 may transmit the data priority information to a terminal device. In some embodiments, the data priority information is determined based on at least one of the following: a remaining storage of the network device; remaining time until the network device connects to a gateway; or a ratio of the remaining storage to the remaining time.

In some embodiments, the data priority information is determined based on at least one of the following: a number of times for which the data has been retransmitted; a data type of the data; a subscription type of the terminal device; a quality of service (QoS) of the data; a latency requirement of the data; a criticality status of the data; or a radio resource control (RRC) establishment cause used by the terminal device.

In some embodiments, the data priority information indicates a lower data priority when the data priority information is associated with a first remaining storage than when the data priority information is associated with a second remaining storage, wherein the second remaining storage is larger than the first remaining storage; the data priority information indicates a lower data priority when the data priority information is associated with a first remaining time than when the data priority information is associated with a second remaining time, wherein the second remaining time is less than the first remaining storage; or the data priority information indicates a lower data priority when the data priority information is associated with a first ratio than when the data priority information is associated with a second ratio, wherein the second ratio is greater than the first ratio.

In some embodiments, the data priority information indicates a lower data priority when the data priority information is associated with the uplink data than when the data priority information is associated with a feedback to downlink data; the data priority information indicates a lower data priority when the data priority information is associated with a first subscription class than when the data priority information is associated with a second subscription class, wherein the second subscription class is higher than the first subscription class; at least one of the QoS, the latency requirement, or the criticality status of the uplink data is determined based on logical channel prioritization.

In some embodiments, the network device is caused to transmit the data priority information by at least one of the following: broadcasting, to a plurality of terminal devices including the terminal device, system information indicating the data priority information; or transmitting, to the terminal device, an RRC message indicating the data priority information. In some embodiments, the network device is caused to transmit the data priority information by based on receiving a scheduling request or a buffer status report from the terminal device, transmitting, to the terminal device, a scheduling grant including the data priority information.

In some embodiments, the network device is caused to transmit the data priority information by based on receiving data from the terminal device, transmitting the data priority information to the terminal device. The data is received in a message 3 during a random access procedure; and the data priority information is transmitted in a message 4 during the random access procedure.

In some embodiments, the network device is further caused to receive, from the terminal device, data and first information indicating that the data is retransmitted data or postponed data; and determine, for the retransmitted data or postponed data, a first priority higher than a second priority for the data in previous transmission. The network device is further caused to transmit, to the terminal device, second information indicating that storage of the network device is exhausted. The second information is transmitted via at least one of the following broadcasted information; a scheduling grant; or a RRC release cause.

In some embodiments, the network device is further caused to based on determining that a remaining storage of the network device is below a threshold size, transmit, to the terminal device, third information indicating that data with at least one of a QoS, a latency requirement, or a criticality status above a threshold level is allowed to be transmitted to the network device. In some embodiments, the network device is further caused to based on dropping data received from the terminal device, transmit, to the terminal device, fourth information indicating that the data is dropped by the network device. The fourth information is transmitted via a paging message for the terminal device.

In some embodiments, the network device is further caused to transmit, to the terminal device, fifth information indicating whether the data priority information applies to one of a plurality of cells of the network device or applies to the plurality of cells. The network device is further caused to transmit, to the terminal device, configuration information for configuring the terminal device with a store-and-forward (SF) access class among a plurality of SF access classes; and broadcast system information indicating at least one barred SF access class among the plurality of SF access classes.

In some embodiments, the network device is further caused to transmit, to the terminal device, sixth information indicating the terminal device to release data from an application buffer of the terminal device or to maintain the data in the application buffer. In some embodiments, the network device is further caused to transmit, to the terminal device, a buffer status report (BSR) in a downlink direction for indicating a share of storage space of the network device for the terminal device.

In some embodiments, an apparatus capable of performing the method 500 (for example, the terminal device 110) may comprise means for performing the respective steps of the method 500. The means may be implemented in any suitable form. For example, the means may be implemented in a circuitry or software module.

In some embodiments, the apparatus comprises means for receiving, from a network device of a non-terrestrial network (NTN), data priority information associated with at least one store-and-forward operation performed by the network device in the NTN; and means for performing, based on the data priority information, an operation for uplink data of the terminal device.

In some embodiments, the data priority information is based on at least one of the following: a remaining storage of the network device; remaining time until the network device connects to a gateway; or a ratio of the remaining storage to the remaining time. In some further embodiments, the data priority information is based on at least one of the following: a number of times for which the data has been retransmitted; a data type of the data; a subscription type of the terminal device; a quality of service (QoS) of the data; a latency requirement of the data; a criticality status of the data; or a radio resource control (RRC) establishment cause used by the terminal device.

In some embodiments, the data priority information indicates a lower data priority when the data priority information is associated with a first remaining storage than when the data priority information is associated with a second remaining storage, wherein the second remaining storage is larger than the first remaining storage; the data priority information indicates a lower data priority when the data priority information is associated with a first remaining time than when the data priority information is associated with a second remaining time, wherein the second remaining time is less than the first remaining storage; or the data priority information indicates a lower data priority when the data priority information is associated with a first ratio than when the data priority information is associated with a second ratio, wherein the second ratio is greater than the first ratio.

In some embodiments, the data priority information indicates a lower data priority when the data priority information is associated with the uplink data than when the data priority information is associated with a feedback to downlink data; the data priority information indicates a lower data priority when the data priority information is associated with a first subscription class than when the data priority information is associated with a second subscription class, wherein the second subscription class is higher than the first subscription class; at least one of the QoS, the latency requirement, or the criticality status of the uplink data is determined based on logical channel prioritization.

In some embodiments, the means for receiving the data priority information comprises at least one of the following: means for receiving, from the network device, system information indicating the data priority information; or means for receiving, from the network device, an RRC message indicating the data priority information. In some embodiments, the apparatus comprises means for transmitting a scheduling request or a buffer status report to the network device, wherein the data priority information is received in a scheduling grant responsive to the scheduling request or the buffer status report.

In some embodiments, the apparatus comprises means for transmitting the data to the network device, wherein the data priority information is received by the terminal device from the network device based on transmitting the data. The data is transmitted in a message 3 during a random access procedure. The data priority information is received in a message 4 during the random access procedure. In some embodiments, the apparatus comprises means for transmitting the data to the network device; means for postponing transmitting the data to the NTN; or means for dropping the data.

In some embodiments, the apparatus comprises means for based on determining that a priority of the data is higher than a first threshold, deleting the data; based on determining that the priority of the data is lower than the first threshold and higher than a second threshold, retransmitting the data or reinitiating a signalling procedure for transmitting the data, after a first time period since an expected time of receiving an acknowledgement of the data; based on determining that the priority of the data is lower than the second threshold, means for retransmitting the data or reinitiating the signalling procedure after a second time period determined based on the priority of the data; or based on determining that the priority of the data is lower than a third threshold, means for retransmitting the data to the first network device or a second network device in the NTN during a subsequent connection to the first network device or the second network device.

In some embodiments, the apparatus comprises means for based on retransmitting the data or reinitiating the signalling procedure, transmit, to the first network device or the second network device, first information indicating that the data is retransmitted data or postponed data. In some embodiments, the means for preventing from transmitting the data to the network device comprises means for determining, based on the data priority information, that the terminal device 110 is barred from accessing a cell of the network device.

In some embodiments, the apparatus comprises means for receiving, from the network device, second information indicating that storage of the network device is exhausted. The second information is received via at least one of the following: broadcasted information; a scheduling grant; or a RRC release cause. In some embodiments, the apparatus comprises means for receiving, from the network device, third information indicating that data with at least one of a QoS, a latency requirement, or a criticality status above a threshold level is allowed to be transmitted to the network device.

In some embodiments, the network device is a first network device, and the apparatus comprises means for based on receiving, from at least one of the first network device or a second network device, fourth information indicating that data transmitted to the first network device is dropped by the first network device, retransmitting the data to the first network device or a second network device in the NTN during a subsequent connection to the first network device or the second network device. The fourth information is received via a paging message for the terminal device.

In some embodiments, the apparatus comprises means for receiving, from the network device, fifth information indicating whether the data priority information applies to one of a plurality of cells of the network device or applies to the plurality of cells. In some embodiments, the apparatus comprises means for obtaining configuration information for configuring the terminal device with a store-and-forward (SF) access class among a plurality of SF access classes; means for receiving, from the network device, system information indicating at least one barred SF access class among the plurality of SF access classes; and determine, based on the SF access class of the terminal device and the at least one barred SF access class, whether the terminal device is barred from accessing a cell of the network device. In some embodiments, the means for obtaining the configuration information comprises means for receiving the configuration information from the network device; or means for determining the configuration information which is predefined for the terminal device.

In some embodiments, the apparatus comprises means for receiving, from the network device, sixth information indicating the terminal device to release the data from an application buffer of the terminal device or to maintain the data in the application buffer. In some embodiments, the apparatus comprises means for receiving, from the network device, a buffer status report (BSR) in a downlink direction for indicating a share of storage of the network device for the terminal device; and means for performing the operation related to the data further based on the BSR. The data priority information comprises at least one of the following: a first priority of first data of the terminal device; or a second priority of second data of the terminal device.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing the method 600 (for example, the network device 120) may comprise means for performing the respective steps of the method 600. The means may be implemented in any suitable form. For example, the means may be implemented in a circuitry or software module. In some embodiments, the apparatus comprises means for determining data priority information associated with at least one store-and-forward operation performed by the network device in a non-terrestrial network (NTN), and means for transmitting the data priority information to a terminal device.

In some embodiments, the data priority information is determined based on at least one of the following: a remaining storage of the network device; remaining time until the network device connects to a gateway; or a ratio of the remaining storage to the remaining time. In some embodiments, the data priority information is determined based on at least one of the following: a number of times for which the data has been retransmitted; a data type of the data; a subscription type of the terminal device; a quality of service (QoS) of the data; a latency requirement of the data; a criticality status of the data; or a radio resource control (RRC) establishment cause used by the terminal device.

In some embodiments, the data priority information indicates a lower data priority when the data priority information is associated with a first remaining storage than when the data priority information is associated with a second remaining storage, wherein the second remaining storage is larger than the first remaining storage; the data priority information indicates a lower data priority when the data priority information is associated with a first remaining time than when the data priority information is associated with a second remaining time, wherein the second remaining time is less than the first remaining storage; or the data priority information indicates a lower data priority when the data priority information is associated with a first ratio than when the data priority information is associated with a second ratio, wherein the second ratio is greater than the first ratio.

In some embodiments, the data priority information indicates a lower data priority when the data priority information is associated with the uplink data than when the data priority information is associated with a feedback to downlink data; the data priority information indicates a lower data priority when the data priority information is associated with a first subscription class than when the data priority information is associated with a second subscription class, wherein the second subscription class is higher than the first subscription class; at least one of the QoS, the latency requirement, or the criticality status of the uplink data is determined based on logical channel prioritization.

In some embodiments, the apparatus comprises means for transmitting the data priority information by at least one of the following: means for broadcasting, to a plurality of terminal devices including the terminal device, system information indicating the data priority information; or means for transmitting, to the terminal device, an RRC message indicating the data priority information. In some embodiments, the apparatus comprises means for transmitting the data priority information by based on means for receiving a scheduling request or a buffer status report from the terminal device, means for transmitting, to the terminal device, a scheduling grant including the data priority information.

In some embodiments, the apparatus comprises means for transmitting the data priority information by based on means for receiving data from the terminal device, means for transmitting the data priority information to the terminal device. The data is received in a message 3 during a random access procedure; and the data priority information is transmitted in a message 4 during the random access procedure.

In some embodiments, the apparatus comprises means for receiving, from the terminal device, data and first information indicating that the data is retransmitted data or postponed data; and means for determining, for the retransmitted data or postponed data, a first priority higher than a second priority for the data in previous transmission. T the apparatus comprises means for transmitting, to the terminal device, second information indicating that storage of the network device is exhausted. The second information is transmitted via at least one of the following broadcasted information; a scheduling grant; or a RRC release cause.

In some embodiments, the apparatus comprises based on means for determining that a remaining storage of the network device is below a threshold size, means for transmitting, to the terminal device, third information indicating that data with at least one of a QoS, a latency requirement, or a criticality status above a threshold level is allowed to be transmitted to the network device. In some embodiments, the apparatus comprises based on means for dropping data received from the terminal device, means for transmitting, to the terminal device, fourth information indicating that the data is dropped by the network device. The fourth information is transmitted via a paging message for the terminal device.

In some embodiments, the apparatus comprises means for transmitting, to the terminal device, fifth information indicating whether the data priority information applies to one of a plurality of cells of the network device or applies to the plurality of cells. The apparatus comprises means for transmitting, to the terminal device, configuration information for configuring the terminal device with a store-and-forward (SF) access class among a plurality of SF access classes; and means for broadcasting system information indicating at least one barred SF access class among the plurality of SF access classes.

In some embodiments, the apparatus comprises means for transmitting, to the terminal device, sixth information indicating the terminal device to release data from an application buffer of the terminal device or to maintain the data in the application buffer. In some embodiments, the apparatus comprises means for transmitting, to the terminal device, a buffer status report (BSR) in a downlink direction for indicating a share of storage space of the network device for the terminal device.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

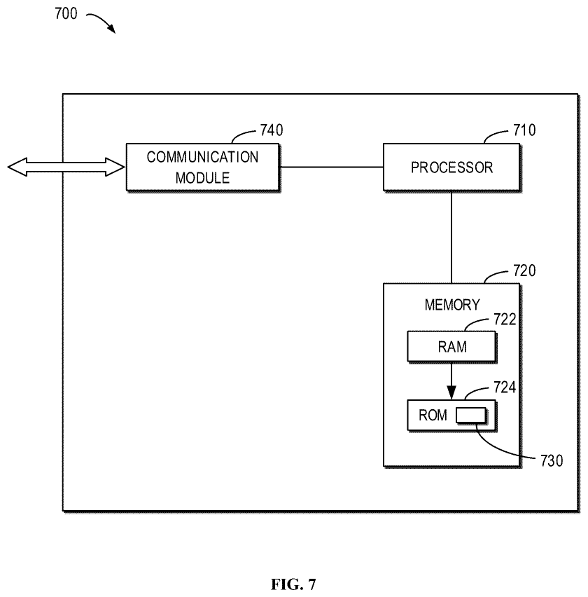

FIG. 7 illustrates a simplified block diagram of a device 700 that is suitable for implementing some example embodiments of the present disclosure. The device 700 may be provided to implement a communication device, for example, the terminal device 110 and the network device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

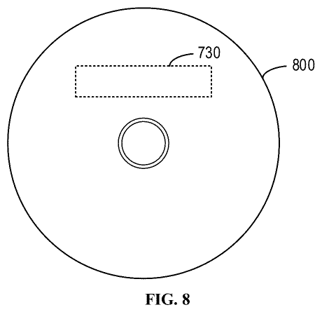

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIG. 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device of a non-terrestrial network (NTN), data priority information associated with at least one store-and-forward operation performed by the network device in the NTN; and
perform, based on the data priority information, an operation for uplink data of the terminal device.

2-31. (canceled)
